(19) United States
(12) Patent Application Publication
(10) Pub. No.: US 2026/0175156 A1
(43) Pub. Date: Jun. 25, 2026

(54) RADIAL FLOW REACTOR WITH CATALYST COVER AND PROCESS FOR RETROFITTING A RADIAL FLOW REACTOR TO INCLUDE SAME

(71) Applicant: UOP LLC, Des Plaines, IL (US)

(72) Inventors: Ka L. Lok, Buffalo Grove, IL (US); Elie J. Fayad, Munster, IN (US); James W. Althoff, Wilmette, IL (US); Steven M. Poklop, Palatine, IL (US); Jeffrey R. Grott, Chicago, IL (US); Hadjira Iddir, Hoffman Estates, IL (US)

(21) Appl. No.: 19/310,488

(22) Filed: Aug. 26, 2025

Related U.S. Application Data
(60) Provisional application No. 63/736,879, filed on Dec. 20, 2024.

(51) Int. Cl. B01D 53/04

(52) U.S. Cl. CPC B01D 53/0431; B01D 53/0446; B01D 2255/915

(57) ABSTRACT

A semi-permeable cover for a radial flow reactor that is located on top of a bed of catalyst in the reactor. The cover allows for a small portion of process gas to flow therethrough. The semi-permeable cover may be a self-deploying blank with a biasing element or have a spiral seam. The cover may be made from separate pieces. A shroud may be provided to cover an upper end of the center pipe in the reactor.

### RELATED APPLICATIONS

This application claims priority to U.S. Provisional Patent Application Ser. No. 63/736,879 filed on Dec. 20, 2024, the entirety of which is incorporated herein by reference.

### FIELD OF THE INVENTION

This invention relates generally to a radial flow reactor and more particularly to a radial flow reactor with a flexible catalyst cover. This invention also relates to a process for retrofitting a radial flow reactor to include a flexible catalyst cover.

### BACKGROUND OF THE INVENTION

A wide variety of chemical processes use radial flow reactors to provide contact between a fluid and a solid. The solid may be a catalytic material on which the fluid reacts to form a product or may be an adsorbent for selectively removing a component from the fluid. The chemical processes cover a wide range of technologies, including, for example, hydrocarbon conversion, gas treatment, and adsorption for separation.

Radial-flow reactors typically include a vertically orientated vessel or reactor shell and a center pipe, with an annular catalyst retention space. One of more scallops extend vertically as well and are radially spaced from the center pipe. Gaseous fluid flows either radially inwardly or outwardly through the annular catalyst retention space to contact the gas with the solid catalyst within the catalyst retention space.

Typically, such radial flow reactors have a large empty space between the top of the catalyst bed and a reactor top head. This empty space contains no catalyst and therefore it does not participate in the reactions to produce the products. Therefore, the reactor vessel is not fully utilized for the catalyst bed to its full extent.

The main reason that the reactor top section space is left open is due to space accessibility requirement for installing and dismantling a cover over the catalyst bed. Some reactors use rigid, metal cover plates that are bolted together inside the reactor. Additionally, some reactors have a pliable, gas impermeable material on top of the catalyst bed. Both of these designs require a sizable amount space to install the catalyst covers inside of the reactor.

For a cover made of rigid metal plates, a large working space below the reactor head is required to allow safe accessibility to install and dissemble the metal cover plates.

For a fabric blanket cover, the blanket typically has a large bending radius compared to the manway used to access the reactor. Thus, the blanket may not be able to be folded sufficiently to pass through the manway. The whole blanket may need to be divided into many smaller pieces in order to pass through the reactor manway for installation. The size width of each individual piece is limited by the size of the manway for the reactor. Similar to metal cover plates, a large void space or working space above the catalyst bed is required for assembling the blanket properly with great risk of disturbing the catalyst. Another problem with the blanket is the potential damage in the flexible blanket after repeated folding and unfolding throughout cycle life, specially the reactor operates at evaluated temperature around 1,000° F.

Accordingly, it would be desirable to have more effective and efficient ways to cover the catalyst in such a reactor which utilizes more space within the reactor for chemical processing.

### SUMMARY OF THE INVENTION

The present inventors have invented a new cover for a radial flow reactor. In some aspects, the cover is semipermeable, allowing some gas flow therethrough. Such a cover is believed to reduce or minimize coking in spaces below the cover. In some aspects, the cover is a self-deploying blanket comprising one or more pieces that self-align or deploy. Such a cover may be installed without requiring a large working space above the catalyst bed. This may allow for more catalyst to be utilized.

Therefore, the present invention may be characterized, in at least one aspect, as providing a radial flow reactor having: a vertically orientated vessel having an inlet and an outlet; a center pipe extending vertically within the vertically orientated vessel; one or more scallops extending vertically within the vertically orientated vessel and spaced radially from the center pipe; a bed of catalyst in between the center pipe and the one or more scallops; and, a semi-permeable covering above the bed of catalyst and configured to direct most of a flow of a gas from the inlet to the one or more scallops.

The radial flow reactor may further include a shroud on an upper end of the center pipe.

The semi-permeable covering may be a self-deploying blanket. The self-deploying blanket may include a biasing element disposed about a perimeter of the self-deploying blanket. The self-deploying blanket may include a spiral spring or bent wire disposed about a perimeter of the self-deploying blanket. The self-deploying blanket may have a spiral seam. The self-deploying blanket may include an overlap portion configured to cover the spiral seam. The self-deploying blanket may have an anchor configured to secure the self-deploying blanket to a portion of the radial flow reactor. The self-deploying blanket may include a gap at a center to accommodate the center pipe.

The radial flow reactor may also include a layer of inert particulate material above the semi-permeable covering, or a layer of inert particulate material below the semi-permeable covering, or both.

In a second aspect, the present invention may be broadly characterized as providing a process for retrofitting a catalyst cover in a radial flow reactor, the radial flow reactor having a vertically orientated vessel having an inlet and an outlet, a center pipe extending vertically within the vertically orientated vessel, one or more scallops extending vertically within the vertically orientated vessel and spaced radially from the center pipe, a bed of catalyst in between the center pipe and the one or more scallops, and, a rigid deck above the bed of catalyst, and the process includes: removing the rigid deck; and, installing a semi-permeable covering above the bed of catalyst. The semi-permeable covering is configured to direct most of a flow of a gas from the inlet to the one or more scallops.

The process may also include installing a layer of inert particulate material above the bed of catalyst before installing the semi-permeable covering.

The process may also include installing a layer of inert particulate material above the semi-permeable covering after installing the semi-permeable covering.

The process may also include installing a layer of inert particulate material above the bed of catalyst before installing the semi-permeable covering.

The process may include installing a perforate covering on an upper end of the center pipe.

The semi-permeable covering may be a self-deploying blanket. The self-deploying blanket may include a biasing member disposed about a perimeter of the self-deploying blanket. The self-deploying blanket may have a spiral seam. The self-deploying blanket may also include an overlap portion configured to cover the spiral seam. The self-deploying blanket may have an anchor to secure the self-deploying blanket to a portion of the radial flow reactor.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

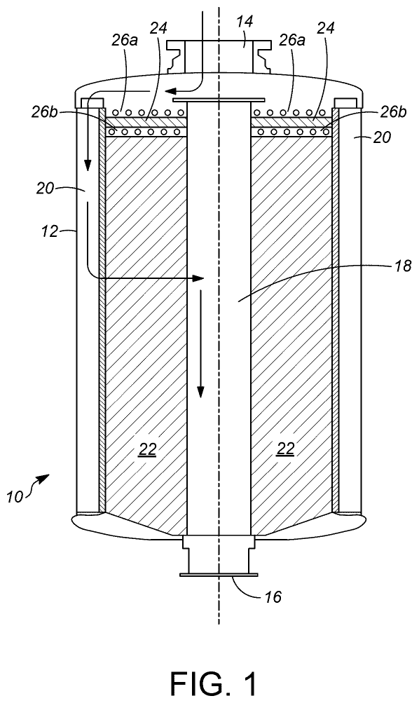

FIG. 1 shows a cross sectional schematic view of a radial flow reactor according to one or more embodiments;

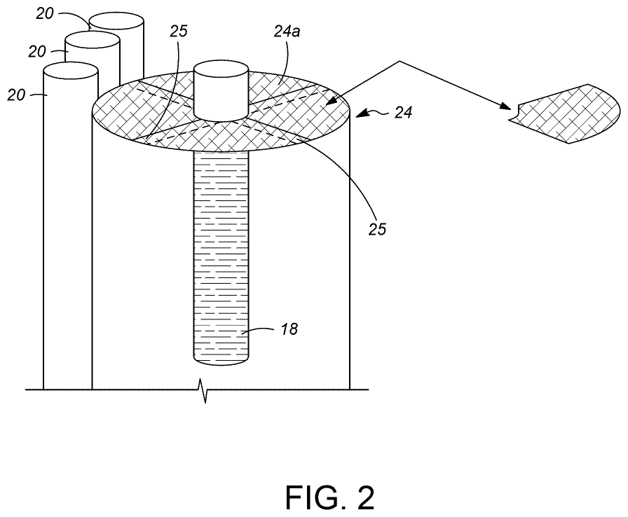

FIG. 2 shows a top perspective view of a portion of a radial flow reactor according to one or more embodiments;

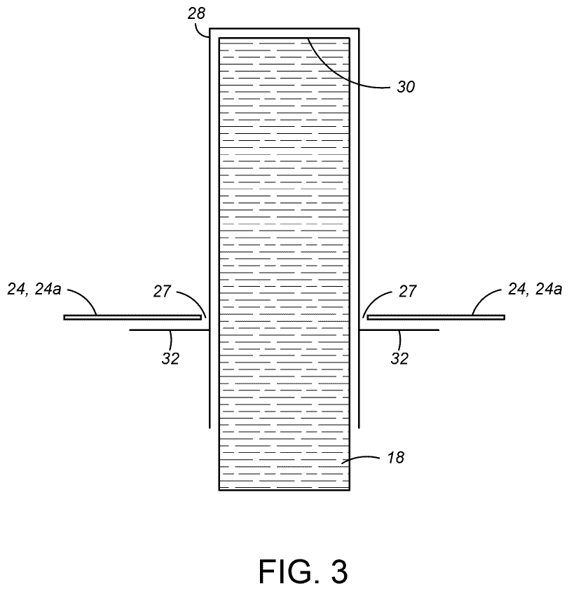

FIG. 3 shows a side perspective view of a center pipe of a radial flow reactor according to one or more embodiments;

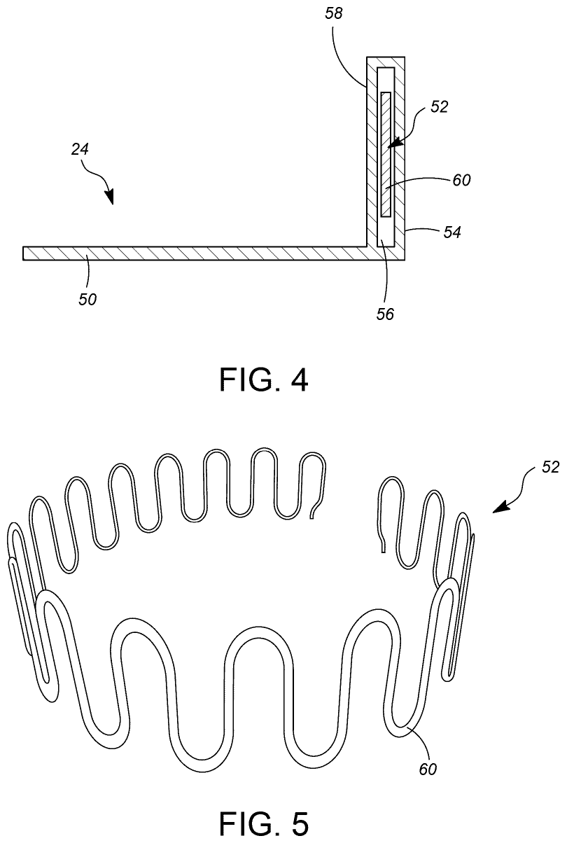

FIG. 4 shows a side cutaway view of a portion of a cover for a radial flow reactor according to one or more embodiments;

FIG. 5 shows a biasing element of the cover of FIG. 4;

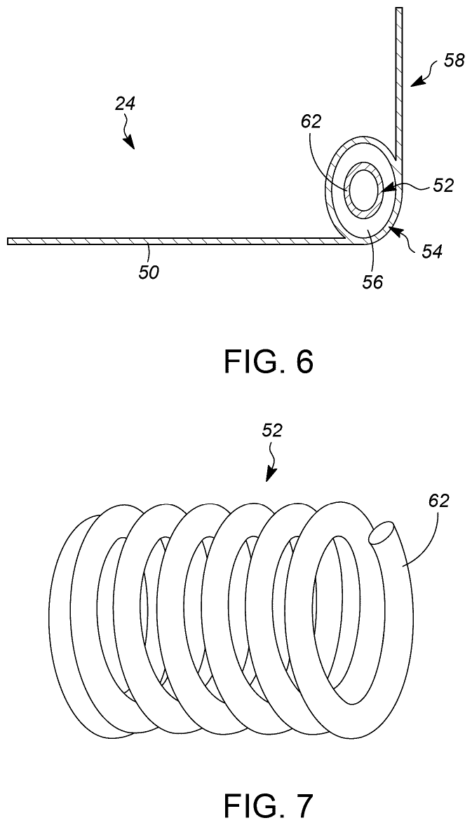

FIG. 6 shows a side cutaway view of a portion of another cover for a radial flow reactor according to one or more embodiments;

FIG. 7 shows a biasing element of the cover of FIG. 6; and,

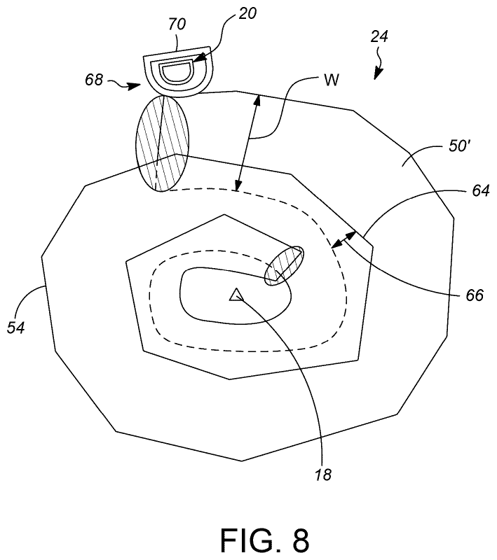

FIG. 8 shows a top view of a further cover for a radial flow reactor according to one or more embodiments.

It should be appreciated and understood by those of ordinary skill in the art that various other components such as center pipe expansion bellows, inert ceramic balls, scallop support rings, etc. were not shown in the drawings as it is believed that the specifics of same are well within the knowledge of those of ordinary skill in the art and a description of same is not necessary for practicing or understating the embodiments of the present invention. In general, the same reference numbers will be used throughout the drawing(s) and accompanying written description to refer to the same or like parts.

### DETAILED DESCRIPTION OF THE INVENTION

As mentioned above, a new cover for a radial flow reactor has been invented. In some aspects of the invented cover, the cover allows for a small amount of flow through the cover to ensure a small, but steady flow in the area under the cover and mitigate abnormal coking and reducing and/or preventing potential fluidization of seal catalyst. In some aspects of the invented cover, the cover is a self-unfolding blanket which opens to a pre-determined size and/or shape covering the catalyst bed without the necessity for reactor entry to large working space above the catalyst bed for installation.

With these general principles in mind, one or more embodiments of the present invention will be described with the understanding that the following description is not intended to be limiting.

Turning to FIG. 1, a radial flow reactor 10 according to various embodiments is shown. The radial flow reactor 10 has a vertically orientated vessel 12 with an inlet 14 and an outlet 16. Although depicted with the inlet 14 at the top of the vessel 12 and the outlet 16 at the bottom, this is merely exemplary.

A center pipe 18 extends vertically within the vertically orientated vessel 12. Additionally, spaced radially outward away from the center pipe 18 are one or more scallops 20. The scallops 20 also extend vertically within the vertically orientated vessel 12. A bed of catalyst 22 is located between the center pipe 18 and the one or more scallops 20. The bed catalyst 22 may be a fixed bed catalyst.

Disposed above the bed of catalyst 22 is a semi-permeable covering 24. The semi-permeable covering 24 is configured to direct most of a flow of a gas from the inlet 14 to the one or more scallops 20. By “most of” it is meant that at least 50%, or at least 75%, or at least 90% of the gas flow does not pass through the semi-permeable covering 24; however, at least 1%, or at least 5% of the gas flow does pass through the semi-permeable covering 24. The semi-permeable covering 24 may a fabric comprised of amorphous silica fibers woven together. Other materials may be utilized provided they are semi-permeable, flexible, inert, and/or suitable to withstand melting or shrinking at high (˜538° C. (1,000° F.)) temperatures.

The semi-permeable covering 24 may be made from a single piece or, as shown in FIG. 2, may be made from multiple pieces 24a. If made from multiple pieces 24a, the semi-permeable covering 24 may include overlapping edges 25. Thus, the individual pieces 24a may be sized larger than is needed to provide the overlapping edges 25 where adjacent pieces 24a meet.

Returning to FIG. 1, in order to hold the semi-permeable covering 24 in position, once deployed, a layer 26a of inert particulate material may be disposed above the semi-permeable covering 24. The inert particulate material of the upper layer 26a may be ceramic balls. Additionally, in order to space the semi-permeable covering 24 above the bed catalyst 22, a layer 26b of inert particulate material may also be disposed below the semi-permeable covering 24. The inert particulate material of the lower layer 26b may be the same or different in some parameter (size, material, etc.) from the inert particulate material of the upper layer 26a. For example, the material in both layers 26a, 26b may be ceramic balls, but the sizes of the ceramic balls in the layers 26a, 26b may be different.

Turning to FIG. 3, the semi-permeable covering 24 may have a gap 27 proximate its center to accommodate the center pipe 18. It is contemplated that a shroud 28 is provided on an upper end 30 of the center pipe 18. The shroud 28 may extend downward on the center pipe 18 beyond the semi-permeable covering 24, but this is not required. Additionally or alternatively, the shroud 28 may include an annular flange portion 32 on which the semi-permeable covering 24 is positioned. The shroud 28 may be permeable or impermeable.

While the semi-permeable covering 24 may have a gap 27, it is contemplated that the semi-permeable covering 24 does not include a gap 27. Further, the semi-permeable covering 24 may instead include a portion sized to cover the center pipe 18 and/or the shroud 28 (if present). Alternatively, the flange 32 of the shroud 28 may be installed above the semi-permeable covering 24 and it may cover any portion of the semi-permeable covering 24 that covers the center pipe 18.

In a preferred configuration, the semi-permeable covering 24 is a self-deploying blanket 50. By “self-deploying” it is meant that the semi-permeable covering 24 is able to expand into mostly (at least 50%) of its desired, deployed configuration when installed in the reactor or inserted into a manway or the reactor inlet 14.

Turning to FIGS. 4 and 5, the self-deploying blanket 50 includes a biasing element 52 disposed about a perimeter 54 of the self-deploying blanket 50. A cavity 56 extends around the perimeter 54 which contains the biasing element 52. The cavity 56 could be formed by folding over an edge of the or the self-deploying blanket 50 by using two layers of material for the self-deploying blanket 50. The self-deploying blanket 50 may also include a wall 58 extending generally upward which may be positioned proximate the scallops 20 when installed.

In the embodiment depicted in FIGS. 4 and 5, the biasing element 52 is a metallic wire 60 bent into undulating waves. The height of the waves may be between a half an inch to 5 inches. Preferably, the length of the metallic wire 60 is equivalent the nearly the inside circumfluence of the scallop ring of the reactor 10. Other shapes, sizes and materials may be used. For example, as shown in FIGS. 6 and 7, the biasing element 52 may be a spiral spring 62.

The biasing element 52 is sized with sufficient flexibility such that it can deform to be passed through a manway or inlet 14 of the reactor 10. When the self-deploying blanket 50 is inside the reactor 10 and placed on top of the catalyst bed 22, the biasing element 52 expands and unfolds the self-deploying blanket 50 to the predetermined circular shape (or arc shape if more than one piece of self-deploying blanket 50 is used). The self-deploying blanket 50 may include the gap 27 and be utilized in conjunction with the shroud 28 (see FIG. 3).

Turning to FIG. 8, another self-deploying blanket 50′ that may be utilized as a cover 24 is depicted. In this self-deploying blanket 50′, the self-deploying blanket 50′ has a spiral seam 64. The self-deploying blanket 50′ may have a circular outer perimeter and be cut to form the continuous long spiral seam 64. It may also be formed from one or more spiral sections.

Due to the nature of the spiral geometry, the spiral blanket self-deploying blanket 50′ will align itself during installation and return to its predetermined shape. As the self-deploying blanket 50′ is inserted through the manway of a reactor 10 and drops downward, it will cover the catalyst bed 22 as the spiral is flattened out. The number of spiral wounds for the self-deploying blanket 50′ may be determined by a D-Factor for a reactor 10 with a given inside diameter and a given manway opening dimensions or the dimensions of the reactor inlet 14. The D-Factor is a ratio of the inlet (or manway) inner diameter to the catalyst bed outer diameter. The number of spirals may be based on approximately one half of a given D-Factor.

The self-deploying blanket 50′ may include an overlapping seam 66 to ensure the catalyst bed is fully covered by the self-deploying blanket 50′ in order to avoid undesirable catalyst fluidization and/or reactant bypassing the normal flow path through the scallops 20 into the center pipe 18. The width W of the spiral wound could be sized with extra section that provide overlap coverage between the seams 66 when the self-deploying blanket 50′ is installed above the catalyst bed 22.

To maintain the position of the self-deploying blanket 50′, the self-deploying blanket 50′ may have an anchor 68 configured to secure the self-deploying blanket 50′ to a portion of the radial flow reactor 10. For example, the anchor 68 may be mounted to or around a scallop 20 or the center pipe 18. The anchors 68 may be stainless steel D-rings 70 or O-rings.

In any of the foregoing embodiments, it is believed that the invented cover 24 will provide the aforementioned benefits in a radial flow reactor 10. It is contemplated that the invented catalyst cover 24 may be retrofitted into an existing radial flow reactor 10 which has a rigid deck above the bed 22 of catalyst.

For example, the retrofitting process may include removing the rigid deck and installing a semi-permeable covering 24 above the bed of catalyst 22.

The process may include installing a layer of inert particulate material 26b above the bed 22 of catalyst before installing the semi-permeable covering 24. Additionally or alternatively, the process may include installing a layer of inert particulate material 26a above the semi-permeable covering 24 after installing the semi-permeable covering 24 on the catalyst bed 22 and/or layer of inert particulate material 26b.

The process may include installing a shroud 28 on an upper end 30 of the center pipe 18. This may be done before installing the semi-permeable covering 24, after installing the semi-permeable covering 24, or at the same time.

The catalyst in the bed 22 may be removed during the process and new, fresh, or the same catalyst may be inserted into the reactor 10.

Of course, the semi-permeable covering 24 may be installed in a new reactor 10 as well.

### Experiments

In a computer flow diagram modeling, it was confirmed that the semi-permeable covering 24 would sufficiently distribute the flow of process fluid to the scallops. There was little-to-no impact on the flow distribution of process fluid within the catalyst bed.

Accordingly, the invented cover provides a simple, yet robust cover for the catalyst to protect the catalyst bed without requiring additional equipment for flow distribution. Additionally, the invented cover may allow for increased utilization of the space within the reactor and allow for the amount of catalyst to be increased.

### Specific Embodiments

While the following is described in conjunction with specific embodiments, it will be understood that this description is intended to illustrate and not limit the scope of the preceding description and the appended claims.

A first embodiment of the invention is a radial flow reactor comprising a vertically orientated vessel having an inlet and an outlet; a center pipe extending vertically within the vertically orientated vessel; one or more scallops extending vertically within the vertically orientated vessel and spaced radially from the center pipe; a bed of catalyst in between the center pipe and the one or more scallops; and, a semi-permeable covering above the bed of catalyst and configured to direct most of a flow of a gas from the inlet to the one or more scallops. An embodiment of the invention is one, any or all of prior embodiments in this paragraph up through the first embodiment in this paragraph, further comprising a shroud on an upper end of the center pipe. An embodiment of the invention is one, any or all of prior embodiments in this paragraph up through the first embodiment in this paragraph, wherein the semi-permeable covering is a self-deploying blanket. An embodiment of the invention is one, any or all of prior embodiments in this paragraph up through the first embodiment in this paragraph, wherein the self-deploying blanket comprises a biasing element disposed about a perimeter of the self-deploying blanket. An embodiment of the invention is one, any or all of prior embodiments in this paragraph up through the first embodiment in this paragraph, wherein the self-deploying blanket comprises a spiral spring or bent wire disposed about a perimeter of the self-deploying blanket. An embodiment of the invention is one, any or all of prior embodiments in this paragraph up through the first embodiment in this paragraph, wherein the self-deploying blanket comprises a spiral seam. An embodiment of the invention is one, any or all of prior embodiments in this paragraph up through the first embodiment in this paragraph, wherein the self-deploying blanket further comprises an overlap portion configured to cover the spiral seam. An embodiment of the invention is one, any or all of prior embodiments in this paragraph up through the first embodiment in this paragraph, wherein the self-deploying blanket comprises an anchor configured to secure the self-deploying blanket to a portion of the radial flow reactor. An embodiment of the invention is one, any or all of prior embodiments in this paragraph up through the first embodiment in this paragraph, wherein the self-deploying blanket comprises a gap at a center to accommodate the center pipe. An embodiment of the invention is one, any or all of prior embodiments in this paragraph up through the first embodiment in this paragraph further comprising a layer of inert particulate material above the semi-permeable covering, or a layer of inert particulate material below the semi-permeable covering, or both.

A second embodiment of the invention is a process for retrofitting a catalyst cover in a radial flow reactor, the radial flow reactor having a vertically orientated vessel having an inlet and an outlet, a center pipe extending vertically within the vertically orientated vessel, one or more scallops extending vertically within the vertically orientated vessel and spaced radially from the center pipe, a bed of catalyst in between the center pipe and the one or more scallops, and, a rigid deck above the bed of catalyst, the process comprising removing the rigid deck; installing a semi-permeable covering above the bed of catalyst, the semi-permeable covering configured to direct most of a flow of a gas from the inlet to the one or more scallops. An embodiment of the invention is one, any or all of prior embodiments in this paragraph up through the second embodiment in this paragraph, further comprising installing a layer of inert particulate material above the bed of catalyst before installing the semi-permeable covering. An embodiment of the invention is one, any or all of prior embodiments in this paragraph up through the second embodiment in this paragraph, further comprising installing a layer of inert particulate material above the semi-permeable covering after installing the semi-permeable covering. An embodiment of the invention is one, any or all of prior embodiments in this paragraph up through the second embodiment in this paragraph, further comprising installing a layer of inert particulate material above the bed of catalyst before installing the semi-permeable covering. An embodiment of the invention is one, any or all of prior embodiments in this paragraph up through the second embodiment in this paragraph, further comprising installing a perforate covering on an upper end of the center pipe. An embodiment of the invention is one, any or all of prior embodiments in this paragraph up through the second embodiment in this paragraph, wherein the semi-permeable covering is a self-deploying blanket. An embodiment of the invention is one, any or all of prior embodiments in this paragraph up through the second embodiment in this paragraph, wherein the self-deploying blanket comprises a biasing member disposed about a perimeter of the self-deploying blanket. An embodiment of the invention is one, any or all of prior embodiments in this paragraph up through the second embodiment in this paragraph, wherein the self-deploying blanket comprises a spiral seam. An embodiment of the invention is one, any or all of prior embodiments in this paragraph up through the second embodiment in this paragraph, wherein the self-deploying blanket further comprises an overlap portion configured to cover the spiral seam. An embodiment of the invention is one, any or all of prior embodiments in this paragraph up through the second embodiment in this paragraph, wherein the self-deploying blanket comprises an anchor configured to secure the self-deploying blanket to a portion of the radial flow reactor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A radial flow reactor comprising:
a vertically orientated vessel having an inlet and an outlet;
a center pipe extending vertically within the vertically orientated vessel;
one or more scallops extending vertically within the vertically orientated vessel and spaced radially from the center pipe;
a bed of catalyst in between the center pipe and the one or more scallops; and,
a semi-permeable covering above the bed of catalyst and configured to direct most of a flow of a gas from the inlet to the one or more scallops.

2. The radial flow reactor of claim 1, further comprising a shroud on an upper end of the center pipe.

3. The radial flow reactor of claim 1, wherein the semi-permeable covering is a self-deploying blanket.

4. The radial flow reactor of claim 3, wherein the self-deploying blanket comprises a biasing element disposed about a perimeter of the self-deploying blanket.

5. The radial flow reactor of claim 3, wherein the self-deploying blanket comprises a spiral spring or bent wire disposed about a perimeter of the self-deploying blanket.

6. The radial flow reactor of claim 3, wherein the self-deploying blanket comprises a spiral seam.

7. The radial flow reactor of claim 6, wherein the self-deploying blanket further comprises an overlap portion configured to cover the spiral seam.

8. The radial flow reactor of claim 3, wherein the self-deploying blanket comprises an anchor configured to secure the self-deploying blanket to a portion of the radial flow reactor.

9. The radial flow reactor of claim 3, wherein the self-deploying blanket comprises a gap at a center to accommodate the center pipe.

10. The radial flow reactor of claim 1 further comprising:
a layer of inert particulate material above the semi-permeable covering, or a layer of inert particulate material below the semi-permeable covering, or both.

11. A process for retrofitting a catalyst cover in a radial flow reactor, the radial flow reactor having a vertically orientated vessel having an inlet and an outlet, a center pipe extending vertically within the vertically orientated vessel, one or more scallops extending vertically within the vertically orientated vessel and spaced radially from the center pipe, a bed of catalyst in between the center pipe and the one or more scallops, and, a rigid deck above the bed of catalyst, the process comprising:
removing the rigid deck;
installing a semi-permeable covering above the bed of catalyst, the semi-permeable covering configured to direct most of a flow of a gas from the inlet to the one or more scallops.

12. The process of claim 11, further comprising:
installing a layer of inert particulate material above the bed of catalyst before installing the semi-permeable covering.

13. The process of claim 11, further comprising:
installing a layer of inert particulate material above the semi-permeable covering after installing the semi-permeable covering.

14. The process of claim 13, further comprising:
installing a layer of inert particulate material above the bed of catalyst before installing the semi-permeable covering.

15. The process of claim 11, further comprising:
installing a perforate covering on an upper end of the center pipe.

16. The process of claim 11, wherein the semi-permeable covering is a self-deploying blanket.

17. The process of claim 16, wherein the self-deploying blanket comprises a biasing member disposed about a perimeter of the self-deploying blanket.

18. The process of claim 16, wherein the self-deploying blanket comprises a spiral seam.

19. The process of claim 18, wherein the self-deploying blanket further comprises an overlap portion configured to cover the spiral seam.

20. The process of claim 18, wherein the self-deploying blanket comprises an anchor configured to secure the self-deploying blanket to a portion of the radial flow reactor.
